(19) United States
(12) Patent Application Publication
(10) Pub. No.: US 2021/0049671 A1
(43) Pub. Date: Feb. 18, 2021

(54) System, Method, and Computer Program Product for Reducing an Amount of Time Associated with a Purchase Order

(71) Applicant: Visa International Service Association, San Francisco, CA (US)

(72) Inventor: Gurpreet Singh Bhasin, Fremont, CA (US)

(21) Appl. No.: 16/541,232

(22) Filed: Aug. 15, 2019

(51) Int. Cl. G06Q 30/06; G06Q 10/08

(52) U.S. Cl. CPC G06Q 30/0635; G06Q 10/08355

(57) ABSTRACT

Disclosed is a computer-implemented method for reducing an amount of time between a time at which a purchase order for one or more items is transmitted and a time at which the one or more items is ready to be picked up by a customer, including selecting a plurality of merchant locations based on pre-order request data associated with the pre-order request, receiving merchant location current wait time data associated with a current wait time of the merchant location, selecting a subset of merchant locations from the first plurality of merchant locations based on the merchant location data associated with each merchant location of the first plurality of merchant locations, and transmitting purchase order data associated with a purchase order for one or more items to a merchant system of a merchant location of the subset of merchant locations. A system and computer program product are also disclosed.

### BACKGROUND

### 1. Field

This disclosed subject matter relates generally to systems, methods, and products for reducing an amount of time associated with a purchase order and, in some particular embodiments or aspects, to a system, method, and computer program product for reducing an amount of time between a time at which a purchase order for one or more items is transmitted and a time at which the one or more items is ready to be picked up by a customer.

### 2. Technical Considerations

Individuals may place orders for items (e.g., goods or services) with a merchant prior to arrival at a location associated with the merchant (e.g., a brick-and-mortar store, a self-service kiosk, and/or the like). For example, an individual may call ahead to have a prescription prepared at a pharmacy or may place an order online to pick up groceries at a grocery store. The goal of these merchants is to provide the goods or services purchased in a timely fashion and ensure that, when possible, the goods or services are ready when the individual arrives.

In some instances, merchants may receive orders and record the orders as they arrive with a merchant system. Merchants may then prepare the orders prior to arrival of the individual picking up the one or more items associated with the order. However, a merchant at a given location may be overwhelmed with orders and, as a result, may either prepare orders too far in advance of the individual's arrival or may complete preparation of the order after the individual has arrived. Similarly, individuals may go out of their way to a different location of the merchant if they anticipate a delay in preparation of their order and, as a result, may increase the amount of travel needed to pick up the one or more items associated with the order.

### SUMMARY

Accordingly, systems, devices, products, apparatus, and/or methods for reducing an amount of time between a time at which a purchase order for one or more items is transmitted and a time at which the one or more items is ready to be picked up by a customer are disclosed that overcome some or all of the deficiencies of the prior art.

According to some non-limiting embodiments or aspects, provided is a computer-implemented method for reducing an amount of time between a time at which a purchase order for one or more items is transmitted and a time at which the one or more items is ready to be picked up by a customer, the computer-implemented method comprising: receiving, with at least one processor, a pre-order request message comprising pre-order request data associated with a pre-order request for one or more items from a user device; receiving, with at least one processor, a first location message comprising first location data associated with a first location of the user device; selecting, with at least one processor, a first plurality of merchant locations from a second plurality of merchant locations based on the pre-order request data associated with the pre-order request and the first location data associated with the first location of the user device; receiving, with at least one processor, merchant location messages comprising merchant location data associated with each merchant location of the first plurality of merchant locations, wherein each of the merchant location messages comprise: item identification data associated with an identification of one or more items offered for sale by the merchant location, merchant location current wait time data associated with a current wait time of the merchant location, wherein the current wait time comprises an amount of time for a customer to receive one or more items after the customer has placed a purchase order for the one or more items at the merchant location, and transmitting, with at least one processor, a pre-order response message comprising at least one of the item identification data and the merchant location current wait time data; receiving, with at least one processor, an order message including data associated with an order for one or more items from the user device; receiving, with at least one processor, a second location message comprising second location data associated with a second location of the user device; selecting, with at least one processor, a subset of merchant locations from the first plurality of merchant locations based on: the merchant location data associated with each merchant location of the first plurality of merchant locations, the data associated with the order, and the second location data associated with the second location of the user device; and transmitting, with at least one processor, a purchase order message comprising purchase order data associated with a purchase order for one or more items to a merchant system of a merchant location of the subset of merchant locations.

According to some non-limiting embodiments or aspects, provided is a system for reducing an amount of time between a time at which a purchase order for one or more items is transmitted and a time at which the one or more items is ready to be picked up by a customer, comprising at least one processor programmed or configured to: receive pre-order request data associated with a pre-order request for one or more items; select a first plurality of merchant locations from a second plurality of merchant locations based on the pre-order request data associated with the pre-order request; receive merchant location data associated with each merchant location of the first plurality of merchant locations, wherein the merchant location data comprises: merchant location current wait time data associated with a current wait time of a merchant location, wherein the current wait time comprises an amount of time for a customer to receive one or more items after the customer has placed a purchase order for the one or more items at the merchant location, and transmitting, with at least one processor, the merchant location current wait time data; receive data associated with an order; select a subset of merchant locations from the first plurality of merchant locations based on the data associated with the order; and transmit purchase order data associated with a purchase order for one or more items to a merchant system of a merchant location of the subset of merchant locations.

According to some non-limiting embodiments or aspects, provided is a computer program product for reducing an amount of time between a time at which a purchase order for one or more items is transmitted and a time at which the one or more items is ready to be picked up by a customer, the computer program product comprising at least one non-transitory computer-readable medium comprising one or more instructions that, when executed by at least one processor, cause the at least one processor to: receive pre-order request data associated with a pre-order request for one or more items; receive first location data associated with a first location of a user device; select a first plurality of merchant locations from a second plurality of merchant locations based on the pre-order request data associated with the pre-order request and the first location data associated with the first location of the user device; receive merchant location data associated with each merchant location of the first plurality of merchant locations, wherein the merchant location data comprises: merchant location current wait time data associated with a current wait time of the merchant location, wherein the current wait time comprises an amount of time for a customer to receive one or more items after the customer has placed a purchase order for the one or more items at the merchant location, and transmit the merchant location current wait time data; receive order data associated with an order for one or more items; receive second location data associated with a second location of the user device; select a subset of merchant locations from the first plurality of merchant locations based on: the merchant location data associated with each merchant location of the first plurality of merchant locations, the order data associated with the order, and the second location data associated with the second location of the user device; and transmit purchase order data associated with a purchase order for one or more items to a merchant system of a merchant location of the subset of merchant locations.

Further non-limiting embodiments or aspects are set forth in the following numbered clauses:

Clause 1: A computer-implemented method for reducing an amount of time between a time at which a purchase order for one or more items is transmitted and a time at which the one or more items is ready to be picked up by a customer, the computer-implemented method comprising: receiving, with at least one processor, a pre-order request message comprising pre-order request data associated with a pre-order request for one or more items from a user device; receiving, with at least one processor, a first location message comprising first location data associated with a first location of the user device; selecting, with at least one processor, a first plurality of merchant locations from a second plurality of merchant locations based on the pre-order request data associated with the pre-order request and the first location data associated with the first location of the user device; receiving, with at least one processor, merchant location messages comprising merchant location data associated with each merchant location of the first plurality of merchant locations, wherein each of the merchant location messages comprise: item identification data associated with an identification of one or more items offered for sale by the merchant location, merchant location current wait time data associated with a current wait time of the merchant location, wherein the current wait time comprises an amount of time for a customer to receive one or more items after the customer has placed a purchase order for the one or more items at the merchant location, and transmitting, with at least one processor, a pre-order response message comprising at least one of the item identification data and the merchant location current wait time data; receiving, with at least one processor, an order message including data associated with an order for one or more items from the user device; receiving, with at least one processor, a second location message comprising second location data associated with a second location of the user device; selecting, with at least one processor, a subset of merchant locations from the first plurality of merchant locations based on: the merchant location data associated with each merchant location of the first plurality of merchant locations, the data associated with the order, and the second location data associated with the second location of the user device; and transmitting, with at least one processor, a purchase order message comprising purchase order data associated with a purchase order for one or more items to a merchant system of a merchant location of the subset of merchant locations.

Clause 2: The computer-implemented method of clause 1, wherein selecting the subset of merchant locations from the first plurality of merchant locations comprises: calculating weighted scores for each merchant location of the first plurality of merchant locations based on the merchant location data associated with each merchant location of the first plurality of merchant locations; and selecting the subset of merchant locations from the first plurality of merchant locations based on the weighted scores for each merchant location of the subset of merchant locations.

Clause 3. The computer-implemented method of clauses 1 or 2, wherein selecting the first plurality of merchant locations from the second plurality of merchant locations comprises: determining a navigable route for a vehicle associated with the user device; and selecting the first plurality of merchant locations from the second plurality of merchant locations based on the navigable route for the vehicle associated with the user device.

Clause 4: The computer-implemented method of any of clauses 1-3, wherein transmitting the purchase order message to the merchant system of the merchant location of the subset of merchant locations comprises: transmitting the purchase order message to the merchant system of the merchant location based on determining that the user device is within a predetermined distance of the merchant location.

Clause 5: The computer-implemented method of any of clauses 1-4, wherein receiving the merchant location messages comprises: receiving a merchant location message from each merchant system of a plurality of merchant systems, wherein each merchant system of the plurality of merchant systems is associated with a merchant location of the first plurality of merchant locations.

Clause 6: The computer-implemented method of any of clauses 1-5, further comprising: transmitting an authorization request message for a payment transaction based on the purchase order data associated with the purchase order for one or more items; receiving an authorization response message including an indication of whether the payment transaction is authorized; and determining that the payment transaction is authorized based on the authorization response message.

Clause 7: The computer-implemented method of any of clauses 1-6, further comprising: selecting the merchant location of the subset of merchant locations based on determining that the merchant location of the subset of merchant locations is the merchant location that is closest to the second location of the user device.

Clause 8: A system for reducing an amount of time between a time at which a purchase order for one or more items is transmitted and a time at which the one or more items is ready to be picked up by a customer, comprising at least one processor programmed or configured to: receive pre-order request data associated with a pre-order request for one or more items; select a first plurality of merchant locations from a second plurality of merchant locations based on the pre-order request data associated with the pre-order request; receive merchant location data associated with each merchant location of the first plurality of merchant locations, wherein the merchant location data comprises: merchant location current wait time data associated with a current wait time of a merchant location, wherein the current wait time comprises an amount of time for a customer to receive one or more items after the customer has placed a purchase order for the one or more items at the merchant location, and transmitting, with at least one processor, the merchant location current wait time data; receive data associated with an order; select a subset of merchant locations from the first plurality of merchant locations based on the data associated with the order; and transmit purchase order data associated with a purchase order for one or more items to a merchant system of a merchant location of the subset of merchant locations.

Clause 9: The system of clause 8, wherein the at least one processor is further programmed or configured to: select the merchant location of the subset of merchant locations based on determining that the merchant location of the subset of merchant locations is the merchant location of the subset of merchant locations that is closest to a location of a user device.

Clause 10: The system of clauses 8 or 9, wherein the at least one processor is further programmed or configured to: select the merchant location from the subset of merchant locations based on determining that the merchant location has the shortest current wait time among the subset of merchant locations.

Clause 11: The system of any of clauses 8-10, wherein when receiving the merchant location data associated with each merchant location of the first plurality of merchant locations, the at least one processor is programmed or configured to: receive the merchant location data associated with each merchant location of the first plurality of merchant locations from each merchant system of a plurality of merchant systems, wherein each merchant system of the plurality of merchant systems is associated with a merchant location of the first plurality of merchant locations.

Clause 12: The system of any of clauses 8-11, wherein the at least one processor is further programmed or configured to: receive location data associated with a location of a user device; and wherein when selecting the first plurality of merchant locations from the second plurality of merchant locations, the at least one processor is programmed or configured to: select the first plurality of merchant locations from the second plurality of merchant locations based on the location data associated with the location and the pre-order request data associated with the pre-order request.

Clause 13: The system of any of clauses 8-12, wherein when selecting the subset of merchant locations from the first plurality of merchant locations, the at least one processor is programmed or configured to: calculate weighted scores for each merchant location of the first plurality of merchant locations based on the merchant location data associated with each merchant location of the first plurality of merchant locations; and select the subset of merchant locations from the first plurality of merchant locations based on the weighted scores for each merchant location of the subset of merchant locations.

Clause 14: The system of any of clauses 8-13, wherein when receiving the pre-order request data associated with the pre-order request for one or more items, the at least one processor is programmed or configured to: receive the pre-order request data associated with the pre-order request for one or more items from a user device; and wherein when selecting the first plurality of merchant locations from the second plurality of merchant locations, the at least one processor is programmed or configured to: determine a navigable route for a vehicle associated with a user device; and select the first plurality of merchant locations from the second plurality of merchant locations based on the navigable route for the vehicle associated with the user device.

Clause 15: A computer program product for reducing an amount of time between a time at which a purchase order for one or more items is transmitted and a time at which the one or more items is ready to be picked up by a customer, the computer program product comprising at least one non-transitory computer-readable medium comprising one or more instructions that, when executed by at least one processor, cause the at least one processor to: receive pre-order request data associated with a pre-order request for one or more items; receive first location data associated with a first location of a user device; select a first plurality of merchant locations from a second plurality of merchant locations based on the pre-order request data associated with the pre-order request and the first location data associated with the first location of the user device; receive merchant location data associated with each merchant location of the first plurality of merchant locations, wherein the merchant location data comprises: merchant location current wait time data associated with a current wait time of the merchant location, wherein the current wait time comprises an amount of time for a customer to receive one or more items after the customer has placed a purchase order for the one or more items at the merchant location, and transmit the merchant location current wait time data; receive order data associated with an order for one or more items; receive second location data associated with a second location of the user device; select a subset of merchant locations from the first plurality of merchant locations based on: the merchant location data associated with each merchant location of the first plurality of merchant locations, the order data associated with the order, and the second location data associated with the second location of the user device; and transmit purchase order data associated with a purchase order for one or more items to a merchant system of a merchant location of the subset of merchant locations.

Clause 16: The computer program product of clause 15, wherein the one or more instructions further cause the at least one processor to: select the merchant location of the subset of merchant locations based on determining that the merchant location of the subset of merchant locations is the merchant location of the subset of merchant locations that is closest to a location of a user device.

Clause 17: The computer program product of clauses 15 or 16, wherein the one or more instructions further cause the at least one processor to: select the merchant location from the subset of merchant locations based on determining that the merchant location has the shortest current wait time among the subset of merchant locations.

Clause 18: The computer program product of any of clauses 15-17, wherein the one or more instructions that cause the at least one processor to receive the merchant location data associated with each merchant location of the first plurality of merchant locations, cause the at least one processor to: receive the merchant location data associated with each merchant location of the first plurality of merchant locations from each merchant system of a plurality of merchant systems, wherein each merchant system of the plurality of merchant systems is associated with a merchant location of the first plurality of merchant locations.

Clause 19: The computer program product of any of clauses 15-18, wherein the one or more instructions that cause the at least one processor to select the subset of merchant locations from the first plurality of merchant locations, cause the at least one processor to: calculate weighted scores for each merchant location of the first plurality of merchant locations based on the merchant location data associated with each merchant location of the first plurality of merchant locations; and select the subset of merchant locations from the first plurality of merchant locations based on the weighted scores for each merchant location of the subset of merchant locations.

Clause 20: The computer program product of any of clauses 15-19, wherein the one or more instructions that cause the at least one processor to receive the pre-order request data associated with the pre-order request for one or more items, cause the at least one processor to: receive the pre-order request data associated with the pre-order request for one or more items from the user device; and wherein the one or more instructions that cause the at least one processor to select the first plurality of merchant locations from the second plurality of merchant locations, cause the at least one processor to: determine a navigable route for a vehicle associated with a user device; and select the first plurality of merchant locations from the second plurality of merchant locations based on the navigable route for the vehicle associated with the user device.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments or aspects that are illustrated in the accompanying schematic figures, in which:

FIG. 1 is a diagram of a non-limiting embodiment or aspect of an environment in which systems, methods, and/or computer program products, described herein, may be implemented according to the principles of the presently disclosed subject matter;

FIG. 2 is a diagram of a non-limiting embodiment or aspect of components of one or more devices of FIG. 1;

FIG. 3 is a flowchart of a non-limiting embodiment or aspect of a process for reducing an amount of time between a time at which a purchase order for one or more items is transmitted and a time at which the one or more items is ready to be picked up by a customer according to the present disclosure; and

FIGS. 4A-4E are a diagram of an implementation of a non-limiting embodiment or aspect of a process disclosed herein.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions such as such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments or aspects, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments or aspects, the account identifier may be an original account identifier, where the original account identifier was provided to a user at the creation of the account associated with the account identifier. In some non-limiting embodiments or aspects, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier of an account that is used as a substitute or replacement for another account identifier, such as a PAN. Tokens may be associated with a PAN or other original account identifier in one or more data structures (e.g., one or more databases) such that they may be used to conduct a payment transaction without directly using an original account identifier. In some non-limiting embodiments or aspects, an original account identifier, such as a PAN, may be associated with a plurality of tokens for different individuals or purposes. In some non-limiting embodiments or aspects, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services, to a user (e.g., a customer, a consumer, and/or the like) based on a transaction such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more electronic devices, which may be used by a merchant to conduct a transaction (e.g., a payment transaction) and/or process a transaction. Additionally or alternatively, a POS device may include peripheral devices, card readers, scanning devices (e.g., code scanners and/or the like), Bluetooth° communication receivers, near-field communication (NFC) receivers, radio frequency identification (RFID) receivers, and/or other contactless transceivers or receivers, contact-based receivers, payment terminals, and/or the like.

As used herein, the term “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments or aspects, a transaction service provider may include a credit card company, a debit card company, a payment network such as Visa®, MasterCard®, American Express®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “payment device” may refer to a payment card (e.g., a credit or debit card), a gift card, a smart card (e.g., a chip card, an integrated circuit card, and/or the like), smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the term “computing device” may refer to one or more electronic devices that are configured to directly or indirectly communicate with or over one or more networks. In some non-limiting embodiments or aspects, a computing device may include a mobile device. A mobile device may include a smartphone, a portable computer, a wearable device (e.g., watches, glasses, lenses, clothing, and/or the like), a personal digital assistant (PDA), and/or other like devices. In some non-limiting embodiments or aspects, a computing device may include a server, a desktop computer, and/or the like.

As used herein, the terms “client” and “client device” may refer to one or more computing devices, such as processors, storage devices, and/or similar computer components, that access a service made available by a server. In some non-limiting embodiments or aspects, a “client device” may refer to one or more devices that facilitate payment transactions, such as one or more POS devices used by a merchant. In some non-limiting embodiments or aspects, a client device may include a computing device configured to communicate with one or more networks and/or facilitate payment transactions such as, but not limited to, one or more desktop computers, one or more mobile devices, and/or other like devices. Moreover, a “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or clients.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

According to some non-limiting aspects or embodiments or aspects, a computer-implemented method for reducing an amount of time between a time at which a purchase order for one or more items is transmitted and a time at which the one or more items is ready to be picked up by a customer are disclosed that include receiving a pre-order request message comprising pre-order request data associated with a pre-order request for one or more items from a user device, receiving a first location message comprising first location data associated with a first location of the user device, selecting a first plurality of merchant locations from a second plurality of merchant locations based on the pre-order request data associated with the pre-order request and the first location data associated with the first location of the user device, receiving merchant location messages comprising merchant location data associated with each merchant location of the first plurality of merchant locations. In some non-limiting embodiments or aspects, each of the merchant location messages comprise item identification data associated with an identification of one or more items offered for sale by the merchant location, merchant location current wait time data associated with a current wait time of the merchant location, where the current wait time comprises an amount of time for a customer to receive one or more items after the customer has placed a purchase order for the one or more items at the merchant location.

In some non-limiting embodiments or aspects, the computer-implemented method may also include transmitting a pre-order response message comprising at least one of the item identification data and the merchant location current wait time data, receiving an order message including data associated with an order for one or more items from the user device, receiving a second location message comprising second location data associated with a second location of the user device, selecting a subset of merchant locations from the first plurality of merchant locations based on the merchant location data associated with each merchant location of the first plurality of merchant locations, the data associated with the order, and the second location data associated with the second location of the user device, and transmitting a purchase order message comprising purchase order data associated with a purchase order for one or more items to a merchant system of a merchant location of the subset of merchant locations.

In this way, embodiments or aspects of the present disclosure including systems, methods, and computer program products, may reduce an amount of time between a time at which a purchase order for one or more items is transmitted and a time at which the one or more items is ready to be picked up by a customer. For example, merchants may accurately forecast the time at which such goods and/or services will be picked up and, as a result, may complete preparation of the goods and/or services close to the time at which the goods and/or services are picked up. This may help to reduce resources needed to maintain the goods at the merchant location prior to pickup by a customer and, by extension, the chance that the goods may deteriorate (e.g., become stale, distasteful, and/or the like). Furthermore, a user device associated with the individual picking up the goods may not need to transmit messages indicating the location of the user device, thereby reducing the need for transmission of messages between the user device and various components of the devices and/or systems described herein.

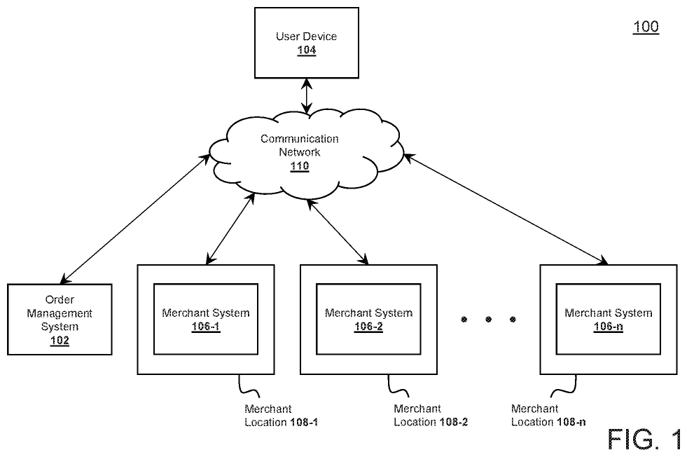

Referring now to FIG. 1, FIG. 1 is a diagram of an example environment 100 in which devices, systems, and/or methods, described herein, may be implemented. As illustrated in FIG. 1, environment 100 may include order management system 102, user device 104, one or more merchant systems 106-1 through 106-n (hereinafter referred to collectively as merchant systems 106 and individually as merchant system 106 unless otherwise specified), and communication network 110. Merchant systems 106 may be associated with merchant locations 108-1 through 108-n (hereinafter referred to collectively as merchant locations 108 and individually as merchant location 108 unless otherwise specified). For example, merchant system 106 maybe located at merchant location 108 or merchant system 106 may be located within a predetermined distance of merchant location 108. In some non-limiting embodiments, merchant system 106 may be configured to communicate with a device (e.g., a POS device) at merchant location 108. In some non-limiting embodiments, merchant location 108 may include a building, a store, a brick and mortar location, and/or the like, of a merchant (e.g., a merchant associated with merchant systems 106). Order management system 102, user device 104, and/or merchant systems 106 may interconnect (e.g., establish a connection to communicate) via wired connections, wireless connections, or a combination of wired and wireless connections.

Order management system 102 may include one or more devices capable of communicating with user device 104 and/or merchant system 106 via communication network 110. For example, order management system 102 may include one or more computing devices, such as a server, a group of servers, and/or the like. In some non-limiting embodiments, merchant system 106 may communicate via a short-range wireless communication connection (e.g., a wireless communication connection for communicating information in a range between a 2-3 centimeters to 5-6 meters, such as an NFC communication connection, an RFID communication connection, a Bluetooth® communication connection, and/or the like). In some non-limiting embodiments, order management system 102 may be associated with a connected vehicle system, a merchant, a transaction service provider, and/or the like.

User device 104 may include one or more devices capable of communicating with order management system 102 and/or merchant system 106 via communication network 110. For example, user device 104 may include one or more computing devices, such as one or more mobile devices, one or more smartphones, one or more wearable devices (e.g., watches, glasses, lenses, clothing, and/or the like), one or more PDAs, one or more vehicle head-units, and/or the like. In some non-limiting embodiments, user device 104 may communicate via a short-range wireless communication connection. In some non-limiting embodiments, user device 104 may be associated with a vehicle (e.g., a car, a bus, a motorcycle, an all-terrain vehicle, and/or the like). In some non-limiting embodiments, user device 104 may include a global positioning system (GPS) component that is built-in to the vehicle (e.g., a GPS component in communication with a vehicle management system such as GM® OnStar®, and/or the like). In some non-limiting embodiments, user device 104 may execute an application configured to communicate with a GPS and/or the Internet such as, without limitation, a satellite maps system, a Google Maps® system, an Apple Maps® system, and/or the like that, in turn, renders a user interface (UI) on a display of user device 104.

Merchant system 106 may include one or more devices capable of communicating with order management system 102 and/or user device 104 via communication network 110. For example, merchant systems 106 may include one or more computing devices, such as one or more servers, one or more client devices, a back-end system (e.g., a back office system), and/or the like. In some non-limiting embodiments, merchant system 106 may be configured to communicate via a short-range wireless communication connection. In some non-limiting embodiments, merchant system 106 may be associated with a merchant as described herein. In some non-limiting embodiments, merchant systems 106 may include one or more devices, such as computers, computer systems, and/or peripheral devices capable of being used by a merchant to conduct a payment transaction with a user via communication network 110 and/or a short-range wireless communication connection. For example, merchant system 106 may include a POS device and/or a POS system.

Communication network 110 may include one or more wired and/or wireless networks. For example, communication network 110 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks shown in FIG. 1 are provided as an example. There may be additional systems, devices, and/or networks, fewer systems, devices, and/or networks, different systems, devices, and/or networks, or differently arranged systems, devices, and/or networks than those shown in FIG. 1. Furthermore, two or more devices, systems, and/or networks shown in FIG. 1 may be implemented within a single device, system, and/or network. Additionally or alternatively, devices, systems, and/or networks shown in FIG. 1 may be implemented as multiple, distributed devices, systems, and/or networks. Additionally, or alternatively, a set of devices or systems (e.g., a plurality of devices or systems) of environment 100 may perform one or more functions described as being performed by another set of devices or systems of environment 100.

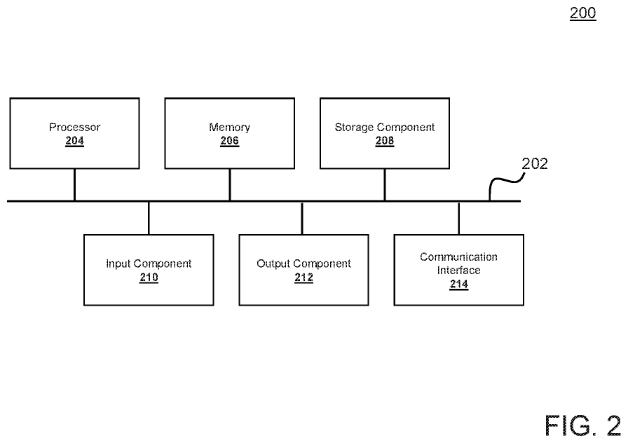

Referring now to FIG. 2, FIG. 2 is a diagram of example components of a device 200. Device 200 may correspond to one or more devices of order management system 102, one or more devices of user device 104, and/or one or more devices of merchant system 106. In some non-limiting embodiments, order management system 102, user device 104, and/or merchant system 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

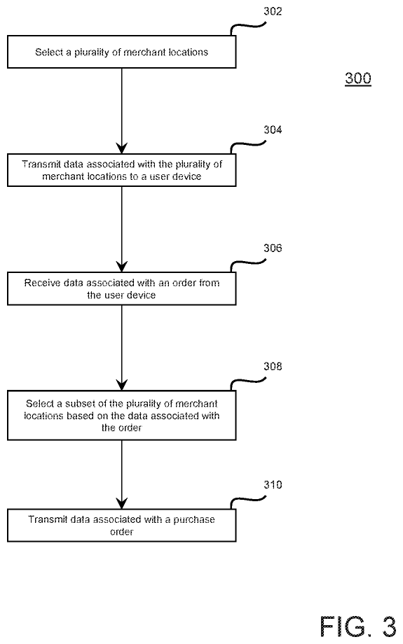

Referring now to FIG. 3, FIG. 3 is a flowchart of a non-limiting embodiment of a process 300 for reducing an amount of time between a time at which a purchase order for one or more items is transmitted and a time at which the one or more items is ready to be picked up by a customer. In some non-limiting embodiments, one or more steps of process 300 may be performed (e.g., completely, partially, and/or the like) by order management system 102 (e.g., one or more order management systems 102, and/or the like). In some non-limiting embodiments, one or more of the steps of process 300 may be performed (e.g., completely, partially, and/or the like) by another device or a group of devices separate from or including user device 104 (e.g., one or more devices of user device 104, and/or the like) and/or merchant system 106 (e.g., one or more devices of merchant system 106, and/or the like).

As shown in FIG. 3, at step 302, process 300 may include selecting a plurality of merchant locations. For example, order management system 102 may select merchant locations 108 from a plurality of merchant locations. In some non-limiting embodiments, order management system 102 may receive a pre-order request message from user device 104 and order management system 102 may select merchant locations 108 from the plurality of merchant locations based on receiving the pre-order request message. In some non-limiting embodiments, order management system 102 may select merchant locations 108 from the plurality of merchant locations based on pre-order request data associated with a pre-order request included in the pre-order request message. For example, order management system 102 may select merchant locations 108 from the plurality of merchant locations within a geographic area (e.g., a state, a city, a town, a zip code, a geographic area within a radius of a location, and/or the like) based on the pre-order request data associated with a pre-order request included in the pre-order request message.

In some non-limiting embodiments, the pre-order request message may include pre-order request data associated with a pre-order request for one or more items. In some non-limiting embodiments, the pre-order request data may include data associated with criteria for determining a merchant location, such as item data associated with criteria for determining a merchant location that offers one or more items for sale, such as a food item (e.g., a solid food item or a liquid food item, such as a drink), location data associated with criteria for determining a merchant location associated with a location (e.g., a merchant location within a predetermined distance of a location of user device 104), navigable route data associated with criteria for determining a merchant location associated with a navigable route (e.g., a merchant location along a navigable route upon which user device 104 is traveling or is going to be traveling), and/or merchant location wait time data associated with criteria for determining a merchant location based on a current wait time of a merchant location.

In some non-limiting embodiments, the one or more items data associated with criteria for determining a merchant location that offers one or more items for sale may include item identification data associated with an identification of one or more items (e.g., a name of one or more items, a brand name of one or more items, a category identifier of one or more items, such as a merchant category of one or more items, and/or the like). In one example, the one or more items may include a food item and the one or more items identification data may include food item identification data associated with an identification of a food item such as, a name of a food item, a brand name of a food item, a category identifier of a food item (e.g., a vegetable food item, a fruit food item, a dairy food item, a quick service, such as fast food, food item, a fair trade food item, a merchant category of a food item, and/or the like), a name of diet (e.g., a name of nutritional diet, such as vegetarian, vegan, meat, ketogenic, low-fat, high-fat, high-protein, high-fiber, and/or the like), a caloric amount of a food item, and/or the like. Additionally or alternatively, the one or more items data associated with criteria for determining a merchant location that offers one or more items for sale may include identification data associated with an identification of a merchant that provides the food item, such as an identifier of the merchant (e.g., a name of the merchant, such as a brand name of the merchant, a merchant category code of the merchant, a type of food service of the merchant, such as fast-food, fine-dining, carry-out, and/or the like). Additionally or alternatively, the one or more items data associated with criteria for determining a merchant location that offers one or more items for sale may include data associated with a desired price for the one or more items and/or a desired threshold of a price for the one or more items.

In some non-limiting embodiments, location data associated with criteria for determining a merchant location associated with a location may include coordinates (e.g., GPS coordinates) of a location, such as a location of user device 104, a location to which user device 104 is going to travel, a previous location of user device 104, a location within a predetermined distance of a location of user device 104, and/or the like. In some examples, the location data associated with criteria for determining a merchant location associated with a location may include a predetermined distance from a location of user device 104 to which a user of user device 104 is willing to travel or is going to be traveling.

In some non-limiting embodiments, the navigable route data associated with criteria for determining a merchant location associated with a navigable route may include coordinates of an origin of the navigable route upon which user device 104 is traveling or is going to be traveling, coordinates of a location along the navigable route upon which user device 104 is traveling or is going to be traveling, and/or coordinates of an endpoint of the navigable route upon which user device 104 is traveling or is going to be traveling.

In some non-limiting embodiments, the merchant location wait time data associated with criteria for determining a merchant location based on a current wait time (e.g., current wait time of a merchant location) may include a time by which one or more items is desired to be picked up by a customer and/or a desired amount of time between a time at which a purchase order for one or more items is transmitted and a time at which the one or more items is ready to be picked up by a customer.

In some non-limiting embodiments, the data associated with criteria for determining a merchant location may include data associated with determining a merchant location of Starbucks® along a navigable route, data associated with determining a merchant location that offers fast food items for sale, such as chicken nuggets, data associated with determining a merchant location that offers a breakfast food item that is under 500 calories and/or has a price that is under $5, data associated with determining a merchant location that offers a vegetarian lunch for sale under $5 and/or a vegetarian lunch that is fair trade, and/or the like.

In some non-limiting embodiments, order management system 102 may determine a navigable route for user device 104 (e.g., a vehicle associated with user device 104, a vehicle in which user device 104 is a component, and/or the like). For example, order management system 102 may determine the navigable route for user device 104 based on navigable route data associated with criteria for determining a merchant location associated with a navigable route. In some non-limiting embodiments, order management system 102 may select merchant locations 108 from the plurality of merchant locations based on the navigable route for user device 104. For example, order management system 102 may select merchant locations 108 from the plurality of merchant locations based on determining that merchant locations 108 are along the navigable route for user device 104 (e.g., are within a predetermined distance of waypoints of the navigable route for user device 104).

In some non-limiting embodiments, user device 104 may receive the data associated with criteria for determining a merchant location as a user input. For example, user device 104 may receive the data associated with criteria for determining a merchant location based on an input received from a user as a voice input (e.g., a voice input received via a voice assistance of user device 104, such as Siri® by Apple®, Alexa® by Amazon®, or Google Assistant® by Google®, an input received from a user as a textual input (e.g., a textual input received via haptic controls of user device 104). In some non-limiting embodiments, user device 104 may generate the data associated with criteria for determining a merchant location using artificial intelligence. For example, user device 104 may generate the data associated with criteria for determining a merchant location based on a machine learning algorithm and historical data associated with criteria for determining a merchant location included in historical pre-order requests made by a user associated with user device 104.

In some non-limiting embodiments, order management system 102 may determine merchant location data associated with each merchant location of the plurality merchant locations. For example, order management system 102 may determine a plurality of merchant locations in a geographic area and order management system 102 may determine merchant location data associated with each merchant location of the plurality of merchant locations. In some non-limiting embodiments, order management system 102 may receive merchant location data associated with each merchant location of the plurality merchant locations from each merchant location of the plurality merchant locations (e.g., from merchant system 106 of each merchant location of the plurality of merchant locations). For example, order management system 102 may receive merchant location messages (e.g., merchant location response messages) that include merchant location data associated with each merchant location of the plurality merchant locations from each merchant location of the plurality merchant locations. In some examples, order management system 102 may receive a merchant location message from each merchant location of the plurality merchant locations that includes the merchant location data associated with a merchant location. In some examples, order management system 102 may receive the merchant location data associated with each merchant location of the plurality merchant locations based on an application programming interface (API) call to merchant system 106 of each merchant location.

In some non-limiting embodiments, order management system 102 may receive the merchant location data associated with each merchant location of the plurality merchant locations based on order management system 102 transmitting a request for merchant location data. For example, order management system 102 may receive a pre-order request message from user device 104 and order management system 102 may transmit a request for merchant location data to each merchant location 108 of the plurality merchant locations 108. In some non-limiting embodiments, the request for merchant location data may include the pre-order request message, some of the pre-order request data included in the pre-order request message, or all of the pre-order request data included in the pre-order request message.

In some non-limiting embodiments, the merchant location data may include merchant location current wait time data associated with a current wait time of a merchant location. A current wait time may include an amount of time for a customer to receive one or more items after the customer has placed a purchase order for the one or more items at the merchant location. In some non-limiting embodiments, the merchant location current wait time data may include data associated with an amount of time for preparation of an order by a merchant at a merchant location, data associated with an amount of time for picking up an order at a merchant location, and/or data associated with an amount of time to travel to a merchant location by diverting from a navigable route. The data associated with an amount of time for preparation of an order by a merchant may be based on a service level agreement of an amount of time to prepare an order (e.g., an order for one item, an order for a plurality of items, and/or the like) at a merchant location during a time interval (e.g., during a time of day). The data associated with an amount of time for picking up an order at a merchant location may be based on an amount of time to travel to a merchant location and to pick up an order via a drive-through window at the merchant location (e.g., during a time interval) or an amount of time to pick up an order via a counter at a merchant location (e.g., during a time interval). The data associated with an amount of time to travel to a merchant location by diverting from a navigable route may be based on an amount of time to travel to a merchant location by diverting from a navigable route upon which a vehicle is traveling (e.g., traveling in real-time).

Additionally or alternatively, the merchant location data may include merchant location item identification data associated with an identification of one or more items (e.g., a name of one or more items, a brand name of one or more items, a category identifier of one or more items, and/or the like) for sale at a merchant location. In one example, the one or more items for sale at a merchant location may include a food item and the merchant location item identification data may include merchant location food item identification data associated with an identification of a food item for sale at the merchant location such as, a name of a food item, a brand name of a food item, a category identifier of a food item (e.g., a vegetable food item, a fruit food item, a dairy food item, a fair trade food item, and/or the like), a name of diet (e.g., a name of nutritional diet, such as vegetarian, vegan, meat, ketogenic, low-fat, high-fat, high-protein, high-fiber, and/or the like), a caloric amount of a food item, and/or the like. Additionally or alternatively, the merchant location data may include merchant location identification data associated with an identification of a merchant that provides one or more items for sale at the merchant location, such as an identifier of the merchant (e.g., a name of the merchant, a merchant category code of the merchant, a type of food service of the merchant, such as fast-food, fine-dining, carry-out, and/or the like). Additionally or alternatively, the merchant location data may include location data associated with a location of the merchant location, such as coordinates (e.g., GPS coordinates) of the location of the merchant location.

Additionally or alternatively, the merchant location data may include merchant location operation data associated with time during which the merchant location is operational, such as a time interval during which the merchant location is open for business, a time interval during which the merchant location provides one or more items (e.g., a food item), and/or the like. Additionally or alternatively, the merchant location data may include merchant location price data associated with a price of one or more items for sale at the merchant location.

In some non-limiting embodiments, merchant system 106 of each merchant location 108 (e.g., merchant system 106-1 of merchant location 180-1, merchant system 106-2 of merchant location 180-2, and/or the like) of merchant locations 108 may determine merchant location current wait time data associated with a current wait time of merchant location 108. In some non-limiting embodiments, merchant system 106 of each merchant location 108 may determine merchant location current wait time data based on receiving a request for merchant location data from order management system 102.

In some non-limiting embodiments, order management system 102 may receive a pre-order request message from user device 104 after execution of an application by user device 104. For example, order management system 102 may receive the pre-order request message based user device 104 executing an application (e.g., a navigation application) on user device 104 located in a vehicle (e.g., user device 104 that is an integrated component of a vehicle).

In some non-limiting embodiments, order management system 102 may receive a pre-order request message from user device 104 and order management system 102 may transmit the pre-order request message to each merchant location of a plurality of merchant locations (e.g., each merchant location 108 of merchant locations 108). In some non-limiting embodiments, order management system 102 may receive a pre-order response message from one or more merchant locations (e.g., one of the merchant locations, some of the merchant locations, or all of the merchant locations) of the plurality of merchant locations. The pre-order response message may include merchant location data associated with the one or more merchant locations.

In some non-limiting embodiments, order management system 102 may select merchant locations 108 from the plurality of merchant locations based on pre-order request data associated with a pre-order request for one or more items. For example, order management system 102 may select merchant locations 108 from a plurality of merchant locations based on determining that the pre-order request data associated with a pre-order request for one or more items (e.g., data associated with determining a merchant location) corresponds to merchant location data associated with each merchant location 108 of merchant locations 108. In some non-limiting embodiments, order management system 102 may select merchant locations 108 from the plurality of merchant locations based on merchant location current wait time data associated with a current wait time of merchant location 108. For example, order management system 102 may select merchant locations 108 from the plurality of merchant locations based on a threshold of time by comparing the merchant location current wait time data at each merchant location of the plurality of merchant locations to the threshold of time. Order management system 102 may select a merchant location if the merchant location current wait time data satisfies the threshold of an amount of time. Order management system 102 may forego selecting the merchant location if the merchant location current wait time data does not satisfy the threshold of an amount of time.

Additionally or alternatively, order management system 102 may select merchant locations 108 from the plurality of merchant locations based on location data associated with a location and/or navigable route data associated with a navigable route. For example, order management system 102 may receive a location message that includes the location data associated with a location and/or a navigable route message that includes the navigable route data associated with a navigable route from user device 104 and order management system 102 may determine a geographic area based on the location data associated with the location and/or the navigable route data associated with a navigable route. Order management system 102 may select merchant locations 108 that are within the geographic area based on merchant location data associated with each merchant location 108 of the plurality merchant locations 108. In some non-limiting embodiments, order management system 102 may determine a predetermined distance from the location based on the location data associated with the location and/or a predetermined distance from the navigable route based on the navigable route data associated with the navigable route. Order management system 102 may select merchant locations 108 that are within the predetermined distance based on merchant location data associated with each merchant location 108 of merchant locations 108.

As shown in FIG. 3, at step 304, process 300 may include transmitting data associated with the plurality of merchant locations to a user device. For example, order management system 102 may transmit merchant location data associated with each merchant location 108 of the plurality merchant locations 108 to user device 104. In some non-limiting embodiments, order management system 102 may transmit a pre-order response message to user device 104 that includes pre-order response message data. For example, order management system 102 may transmit the pre-order response message based on receiving a pre-order request message from user device 104. In some non-limiting embodiments, the pre-order response message data may include merchant location data associated with each merchant location 108 of the plurality merchant locations 108. For example, the pre-order response message data may include merchant location data received by order management system 102 from one or more merchant locations (e.g., merchant location data that was included in a pre-order response message from one or more merchant locations).

As shown in FIG. 3, at step 306, process 300 may include receiving data associated with an order from the user device. For example, order management system 102 may receive an order message that includes order data associated with an order for one or more items from user device 104. In some non-limiting embodiments, the order data associated with an order for one or more items may include item data associated with one or more items, such as a food item (e.g., a solid food item or a liquid food item, such as a drink), location data associated with a location (e.g., a location associated with user device 104), and/or navigable route data associated with a navigable route (e.g., a navigable route upon which user device 104 is traveling or is going to be traveling). In some non-limiting embodiments, the one or more items data associated with one or more items may include item identification data associated with an identification of one or more items (e.g., a name of one or more items, a brand name of one or more items, a category identifier of one or more items, and/or the like). In one example, the one or more items may include a food item and the one or more items identification data may include food item identification data associated with an identification of a food item such as, a name of a food item, a brand name of a food item, a category identifier of a food item (e.g., a vegetable food item, a fruit food item, a dairy food item, a fair trade food item, and/or the like), a name of diet (e.g., a name of nutritional diet, such as vegetarian, vegan, meat, ketogenic, low-fat, high-fat, high-protein, high-fiber, and/or the like), a caloric amount of a food item, and/or the like. Additionally or alternatively, the one or more items data associated with one or more items may include identification data associated with an identification of a merchant that provides the food item, such as an identifier of the merchant (e.g., a name of the merchant, a merchant category code of the merchant, a type of food service of the merchant, such as fast-food, fine-dining, carry-out, and/or the like).

In some non-limiting embodiments, location data associated with a location may include coordinates (e.g., GPS coordinates) of a location, such as a location of user device 104, a location to which user device 104 is going to travel, a previous location of user device 104, a location within a predetermined distance of a location of user device 104, and/or the like. In some examples, the location data associated with a location may include a predetermined distance from a location of user device 104 to which a user of user device 104 is willing to travel or is going to be traveling.

In some non-limiting embodiments, the navigable route data associated with a navigable route may include coordinates of an origin of the navigable route upon which user device 104 is traveling or is going to be traveling, coordinates of a location along the navigable route upon which user device 104 is traveling or is going to be traveling, and/or coordinates of an endpoint of the navigable route upon which user device 104 is traveling or is going to be traveling.

In some non-limiting embodiments, user device 104 may receive the order data associated with an order as a user input. For example, user device 104 may receive the data associated with the order based on an input received from a user as a voice input (e.g., a voice input received via a voice assistance of user device 104, such as Siri® by Apple®, Alexa® by Amazon®, or Google Assistant® by Google®, an input received from a user as a textual input (e.g., a textual input received via haptic controls of user device 104). In some non-limiting embodiments, user device 104 may generate the data associated with the order using artificial intelligence. For example, user device 104 may generate the data associated with the order based on a machine learning algorithm and historical data associated with historical orders made by a user associated with user device 104.

In some non-limiting embodiments, order management system 102 may store the order data associated with an order received from user device 104. For example, order management system 102 may store the order data associated with an order received from user device 104 in a cache memory component of order management system 102. In this way, order management system 102 may more quickly retrieve the data associated with an order received from user device 104 than if the data associated with the order is stored in another memory component of order management system 102, such as a main memory component (e.g., a RAM memory component).

As shown in FIG. 3, at step 308, process 300 may include selecting a subset of the plurality of merchant locations based on the data associated with the order. For example, order management system 102 may select a subset of merchant locations 108 (e.g., one or more merchant locations 108 of merchant locations 108, merchant location 108-1 of merchant locations 108, merchant location 108-1 and merchant location 108-2 of merchant locations 108, and/or the like) based on the data associated with the order. In some non-limiting embodiments, order management system 102 may receive an order message from user device 104 and order management system 102 may select the subset of merchant locations 108 from merchant locations 108 based on receiving an order message. In some non-limiting embodiments, order management system 102 may select the subset of merchant locations 108 from merchant locations based on the data associated with an order included in the order message. For example, order management system 102 may select the subset of merchant locations 108 from merchant locations 108 within a geographic area based on the data associated with an order included in the order message. In another example, order management system 102 may select the subset of merchant locations 108 from merchant locations 108 that are a predetermined distance from a location associated with user device 104 based on the data associated with an order included in the order message. In another example, order management system 102 may select the subset of merchant locations 108 from merchant locations 108 that offer one or more items based on the data associated with an order included in the order message.

In some non-limiting embodiments, order management system 102 may receive an order message from user device 104 and order management system 102 may transmit the order message to each merchant location 108 of merchant locations 108. In some non-limiting embodiments, order management system 102 may receive an order response message from the subset of merchant locations 108. The order response message may include merchant location data associated with each merchant location 108 of the subset of merchant locations 108.

In some non-limiting embodiments, order management system 102 may select the subset of merchant locations 108 from merchant locations 108 based on order data associated with an order for one or more items and merchant location data (e.g., updated merchant location data) associated with each merchant location 108 of the subset of merchant locations 108. For example, order management system 102 may select the subset of merchant locations 108 from merchant locations 108 based on determining that the data associated with the order for one or more items corresponds to merchant location data associated with each merchant location 108 of the subset of merchant locations 108. In one example, order management system 102 may select merchant location 108 based on item identification data associated with one or more items for sale at merchant location 108.

Additionally or alternatively, order management system 102 may select the subset of merchant locations 108 based on location data associated with a location and/or navigable route data associated with a navigable route. For example, order management system 102 may receive a location message that includes the location data associated with a location and/or a navigable route message that includes the navigable route data associated with a navigable route from user device 104 and order management system 102 may determine a geographic area based on the location data associated with the location and/or the navigable route data associated with a navigable route. Order management system 102 may select the subset of merchant locations 108 that are within the geographic area based on merchant location data associated with each merchant location 108 of the subset of merchant locations 108. In one example, order management system 102 may select merchant location 108 based on the navigable route data associated with a navigable route received from user device 104. Order management system 102 may determine that merchant location 108 is along the navigable route and order management system 102 may select merchant location 108.

In some non-limiting embodiments, order management system 102 may determine a predetermined distance from the location based on the location data associated with the location and/or a predetermined distance from the navigable route based on the navigable route data associated with the navigable route. Order management system 102 may select the subset of merchant locations 108 that are within the predetermined distance based on merchant location data associated with each merchant location 108 of the subset of merchant locations 108.

In some non-limiting embodiments, order management system 102 may select the subset of merchant locations 108 based on each merchant locations of the subset of merchant locations being with a threshold distance of a location of user device 104. For example, order management system 102 may determine a distance of each merchant location 108 of merchant locations 108 from a location of user device 104. Order management system 102 may compare the distance of each merchant location 108 of merchant locations 108 to the location of user device 104 to the threshold distance. If order management system 102 determines that the distance of merchant location 108 satisfies the threshold distance, order management system 102 may select merchant location 108. If order management system 102 determines that the distance of merchant location 108 does not satisfy the threshold distance, order management system 102 may forego selecting merchant location 108.

In some non-limiting embodiments, order management system 102 may select the subset of merchant locations 108 based on each merchant locations of the subset of merchant locations being with a threshold distance of a navigable route upon which user device 104 is traveling or is going to be traveling. For example, order management system 102 may determine a distance of each merchant location 108 of merchant locations 108 from the navigable route upon which user device 104 is traveling or is going to be traveling. Order management system 102 may compare the distance of each merchant location 108 of merchant locations 108 to a navigable route upon which user device 104 is traveling or is going to be traveling to the threshold distance. If order management system 102 determines that the distance of merchant location 108 satisfies the threshold distance, order management system 102 may select merchant location 108 to be in the subset. If order management system 102 determines that the distance of merchant location 108 does not satisfy the threshold distance, order management system 102 may forego selecting merchant location 108 to be in the subset.

In some non-limiting embodiments, order management system 102 may receive merchant location data (e.g., updated merchant location data) associated with each merchant location 108 of the subset of merchant locations 108. For example, order management system 102 may receive merchant location messages (e.g., merchant location response messages) that include the merchant location data based on order management system 102 transmitting a request for merchant location data (e.g., an updated request for merchant location data) to the subset of merchant locations 108. In some non-limiting embodiments, order management system 102 may receive an order message from user device 104 and order management system 102 may transmit the request for merchant location data to the subset of merchant locations 108. In some non-limiting embodiments, the request for merchant location data may include the order message, some of the order data associated with an order included in the order message, or all of the order data associated with an order included in the order message.

In some non-limiting embodiments, merchant system 106 of each merchant location 108 (e.g., merchant system 106-1 of merchant location 180-1, merchant system 106-2 of merchant location 180-2, and/or the like) of the subset of merchant locations 108 may determine updated merchant location current wait time data associated with a current wait time of merchant location 108. For example, merchant system 106 of each merchant location 108 of the subset of merchant locations 108 may determine updated data associated with an amount of time for preparation of an order by a merchant at merchant location 108, updated data associated with an amount of time for picking up an order at merchant location 108, and/or updated data associated with an amount of time to travel to merchant location 108 by diverting from a navigable route based on receiving a request for merchant location data from order management system 102. The updated merchant location current wait time data associated with a current wait time of merchant location 108 may be the same or similar to merchant location current wait time data associated with a current wait time of merchant location 108 previously determined by merchant system 106 based on receiving a request for merchant location data from order management system 102. In some non-limiting embodiments, merchant system 106 of each merchant location 108 of the subset of merchant locations 108 may transmit the updated merchant location current wait time data to order management system 102 based on receiving a request for merchant location data (e.g., an updated request for merchant location data) from order management system 102.

In some non-limiting embodiments, order management system 102 may select the subset of merchant locations 108 or merchant locations 108 from a plurality of merchant locations based on calculating a weighted score for each merchant location (e.g., each merchant location 108 of merchant locations 108, each merchant location of a plurality of merchant locations, and/or the like). For example, order management system 102 may calculate a weighted score for each merchant location of a plurality of merchant locations based on the formula:

Weighted score=(W1* a score associated with a current wait time of a merchant location+W2* a score associated with a price for the one or more food items of an order+W3* a score associated with a caloric amount of one or more food items of an order +W4* a score associated with a number of times a purchase order has been provided to a merchant location during a historical time interval+W5* a score associated with a diet preference for one or more food items of an order)/((W1*+W2*+W3*+W4*+W5*)) where:
W1* is a weight factor assigned to a current wait time of a merchant location;
W2* is a weight factor assigned to a price for the one or more food items of an order;
W3* is a weight factor assigned to a caloric amount of one or more food items of an order;
W4* is a weight factor assigned to a number of times a purchase order has been provided to a merchant location during a historical time interval; and
W5* is a weight factor assigned to a diet preference for one or more food items of an order.

Order management system 102 may select may select merchant locations 108 from the plurality of merchant locations based on a weighted score for each merchant location 108 of merchant locations 108 satisfying a threshold of a weighted score. In some non-limiting embodiments, order management system 102 may calculate the score associated with a current wait time of a merchant location, the score associated with a price for the one or more food items of an order, the score associated with a caloric amount of one or more food items of an order, the score associated with a number of times a purchase order has been provided to a merchant location during a historical time interval, and/or the score associated with a diet preference for one or more food items of an order based on pre-order request data associated with a pre-order request for one or more items. In some non-limiting embodiments, the score associated with a number of times a purchase order has been provided to a merchant location during a historical time interval may provide an indication that the merchant location is not to be selected until a time interval has passed. For example, the score associated with a number of times a purchase order has been provided to the merchant location during a historical time interval may provide an indication that the merchant location is not to be selected until a predetermined number of days has passed. In some non-limiting embodiments, one or more of the weight factors W1 through W5 may be received by order management system 102 based on a user input provided by a user to user device 104. In some non-limiting embodiments, one or more of the weight factors W1 through W5 may be determined by order management system 102.

In some non-limiting embodiments, order management system 102 may calculate a weighted score for each merchant location 108 of merchant locations 108 based on the pre-order request data associated with a pre-order request for one or more items, the location data associated with a location of user device 104, merchant location data associated with each merchant location 108 of merchant locations 108, and/or merchant location current wait time data associated with a current wait of each merchant location 108 of merchant locations 108.

In some non-limiting embodiments, order management system 102 may select merchant locations 108 from the plurality of merchant locations based on a stochastic algorithm such as a roulette wheel selection algorithm. For example, order management system 102 may apply a stochastic algorithm to a set of weighted scores for each of the plurality of merchant locations. The output of the stochastic algorithm may include a set of merchant locations that includes merchant locations 108. In some non-limiting embodiments, one or more of the weight factors W1 through W5 may be randomly applied to each of the score associated with a current wait time of a merchant location, the score associated with a price for the one or more food items of an order, the score associated with a caloric amount of one or more food items of an order, the score associated with a number of times a purchase order has been provided to a merchant location during a historical time interval, and/or the score associated with a diet preference for one or more food items of an order. A stochastic algorithm may be a random algorithm or a fair algorithm based on the weight factors being assigned to the scores (e.g., one or more of the weight factors W1 through W5 being assigned to the score associated with a current wait time of a merchant location, the score associated with a price for the one or more food items of an order, the score associated with a caloric amount of one or more food items of an order, the score associated with a number of times a purchase order has been provided to a merchant location during a historical time interval, and/or the score associated with a diet preference for one or more food items of an order) such that a selection of merchant locations may be proportional to the weighted score of a merchant location. In some non-limiting embodiments, stochastic algorithm may be a gamed algorithm or an unfair algorithm. For example, the stochastic algorithm may include a merchant location weight factor for a merchant location, where the weight factor for the merchant location is configured to increase a weighted score for the merchant location as compared to the weighted score for the merchant location without the merchant location weight factor for the merchant location. In some non-limiting embodiments, the merchant location weight factor for the merchant location may be based on a service fee provided by the merchant location to increase the weighted score of the merchant location.

In some non-limiting embodiments, order management system 102 may determine an updated weighting factor. For example, order management system 102 may determine an updated weighting factor used to calculate a weighted score for one or more items based on historical data associated with at least one historical pre-order request and/or at least one historical order.

As shown in FIG. 3, at step 310, process 300 may include transmitting data associated with a purchase order. For example, order management system 102 may transmit a purchase order message that includes the purchase order data associated with the purchase order for one or more items to merchant system 106 of a first merchant location 108 (e.g., merchant system 106-1 of merchant location 108-1, merchant system 106-2 of merchant location 108-2, and/or the like) of the subset of merchant locations 108. In some non-limiting embodiments, order management system 102 may transmit the purchase order data associated with the purchase order for one or more items to merchant system 106 of the first merchant location 108 based on receiving a purchase order message from user device 104. The purchase order message may include an indication of a selection of the first merchant location 108 of the subset of merchant locations 108.

In some non-limiting embodiments, user device 104 may transmit the purchase order message to order management system 102 based on a user input received from a user associated with user device 104. For example, user device 104 may receive updated merchant location data associated with each merchant location 108 of the subset of merchant locations 108. User device 104 may receive a selection of the first merchant location 108 of the subset of merchant locations 108 as a user input from the user. User device 104 may generate the purchase order message and transmit the purchase order message to order management system 102 based on receiving the selection of the first merchant location 108 of the subset of merchant locations 108.

In some non-limiting embodiments, order management system 102 may transmit the purchase order data associated with the purchase order to merchant system 106 of the first merchant location 108 based on selecting the first merchant location 108. For example, order management system 102 may transmit the purchase order data to merchant system 106 of the first merchant location 108 based on order management system 102 selecting the first merchant location 108 from the subset of merchant locations 108. In some non-limiting embodiments, order management system 102 may select the first merchant location 108 from the subset of merchant locations 108 based on item identification data associated with an identification of one or more items offered for sale at the first merchant location 108, merchant location price data associated with a price of the one or more items for sale at the first merchant location 108, and merchant location current wait time data associated with current wait time of the first merchant location 108.

In some non-limiting embodiments, order management system 102 may select the first merchant location 108 from the subset of merchant locations 108 based on a customer rewards program offered by a merchant associated with the first merchant location 108. For example, order management system 102 may determine a customer rewards program in which a user associated with user device 104 is enrolled. Order management system 102 may select the first merchant location 108 from the subset of merchant locations 108 based on the customer rewards program in which the user associated with user device 104 is enrolled corresponding to the customer rewards program offered by a merchant associated with the first merchant location 108. In some non-limiting embodiments, order management system 102 may select the first merchant location 108 from the subset of merchant locations 108 based on an amount of rewards associated with a customer rewards program offered by a merchant associated with the first merchant location 108. For example, order management system 102 may select the first merchant location 108 from the subset of merchant locations 108 based on the amount of rewards associated with the customer rewards program offered by the merchant associated with the first merchant location 108 being the highest amount of rewards among an amount of rewards offered by customer rewards programs offered by merchants associated with the subset of merchant locations 108.

In some non-limiting embodiments, order management system 102 may select the first merchant location 108 from the subset of merchant locations 108 based on determining that the first merchant location 108 is the merchant location that is closest to a location of user device 104. In such an example, order management system 102 may compare the distance of each merchant location 108 of the subset of merchant locations 108 to the location of user device 104 to each other. Order management system 102 may determine that the distance from the first merchant location 108 to the location of user device 104 is the smallest distance of the distances from each merchant location 108 to the location of user device 104 (e.g., that the first merchant location 108 is closest to the location of user device 104).

In some non-limiting embodiments, order management system 102 may select the first merchant location 108 of the subset of merchant locations 108 based on determining that the first merchant location 108 is closest to the navigable route upon which user device 104 is traveling or is going to be traveling. For example, order management system 102 may compare the distance from each merchant location 108 of merchant locations 108 to the navigable route (e.g., a location on the navigable route, such as a waypoint on the navigable route) upon which user device 104 is traveling or is going to be traveling to each other. Order management system 102 may determine that the distance from the first merchant location 108 to the navigable route upon which user device 104 is traveling or is going to be traveling is the smallest distance of the distances from each merchant location 108 to the navigable route (e.g., that the first merchant location 108 is closest to the navigable route upon which user device 104 is traveling or is going to be traveling).

In some non-limiting embodiments, order management system 102 may select the first merchant location 108 from the subset of merchant locations 108 based on determining that the first merchant location 108 has the shortest current wait time among the subset of merchant locations 108. In such an example, order management system 102 may compare the current wait time of each merchant location 108 of the subset of merchant locations 108 to each other. Order management system 102 may determine that the current wait time of the first merchant location 108 is the smallest current wait time of the current wait times of each merchant location 108 of the subset of merchant locations (e.g., that the first merchant location 108 has the shortest current wait time among the subset of merchant locations 108).

In some non-limiting embodiments, order management system 102 may select the first merchant location 108 from the subset of merchant locations 108 and order management system 102 may transmit a confirmation request message to user device 104 before transmitting a purchase order message to the first merchant location 108. In some non-limiting embodiments, order management system 102 may transmit the purchase order message to the first merchant location 108 based on receiving a confirmation response message from user device 104 that includes an indication that a user associated with user device 104 approves a selection of the first merchant location 108.

In some non-limiting embodiments, order management system 102 may conduct a payment transaction involving a merchant associated with the first merchant location 108 and a user associated with user device 104. For example, order management system 102 may transmit purchase order data associated with a purchase order for one or more items to merchant system 106 of the first merchant location 108 based on receiving a purchase order message from user device 104. Order management system 102 may receive a purchase order confirmation message from merchant system 106 of the first merchant location 108 that includes an indication that the purchase order data associated with the purchase order for the one or more items was received by merchant system 106 and that the one or more items is being prepared by the first merchant location 108. Order management system 102 may conduct the payment transaction based on receiving the purchase order confirmation message from merchant system 106 of the first merchant location 108. In some non-limiting embodiments, order management system 102 may transmit an authorization request message for a payment transaction based on the purchase order data associated with the purchase order for one or more items and order management system 102 may receive an authorization response message (e.g., an authorization response message from an issuer system, an authorization response message from a transaction service provider system, and/or the like) including an indication of whether the payment transaction is authorized. In some non-limiting embodiments, order management system 102 may determine that the payment transaction is authorized based on the authorization response message. In some non-limiting embodiments, order management system 102 may transmit a confirmation message based on determining that the payment transaction is authorized. For example, order management system 102 may determine that the payment transaction is authorized based on an indication that the payment transaction was authorized included in the authorization response message. Order management system 102 may transmit the confirmation message to user device 104 and/or merchant system 106 of the first merchant location 108 based on determining that the payment transaction is authorized.

In some non-limiting embodiments, order management system 102 may store the purchase order data associated with a purchase order received from user device 104. For example, order management system 102 may store the purchase order data associated with a purchase order received from user device 104 in a cache memory component of order management system 102. In this way, order management system 102 may more quickly retrieve the purchase order data associated with a purchase order received from user device 104 than if the data associated with the purchase order is stored in another memory component of order management system 102, such as a main memory component (e.g., a RAM memory component).

In some non-limiting embodiments, order management system 102 may transmit the purchase order data associated with the purchase order to merchant system 106 of the first merchant location 108 based on determining that user device 104 is within a predetermined distance of the first merchant location 108. For example, order management system 102 may determine a location of user device 104 and order management system 102 may determine merchant location current wait time data associated with a current wait time of the first merchant location 108. Order management system 102 may determine an amount of time for user device 104 to travel within a predetermined distance of the first merchant location 108. Order management system 102 may transmit the purchase order data associated with the purchase order to merchant system 106 of the first merchant location 108 after the amount of time has elapsed. In some non-limiting embodiments, order management system 102 may determine the predetermined distance of the first merchant location 108 based on merchant location current wait time data associated with a current wait time of the first merchant location 108.

In some non-limiting embodiments, order management system 102 may transmit a purchase order confirmation message to user device 104 based on transmitting the purchase order data associated with the purchase order to merchant system 106 of the first merchant location 108. For example, order management system 102 may transmit the purchase order confirmation message, which includes an indication that the purchase order data was transmitted to merchant system 106 of the first merchant location 108, based on transmitting the purchase order data to merchant system 106 of the first merchant location 108. In some non-limiting embodiments, user device 104 may display directions to travel to the first merchant location 108. For example, user device 104 may display directions to travel to the first merchant location 108 based on receiving the purchase order confirmation message.

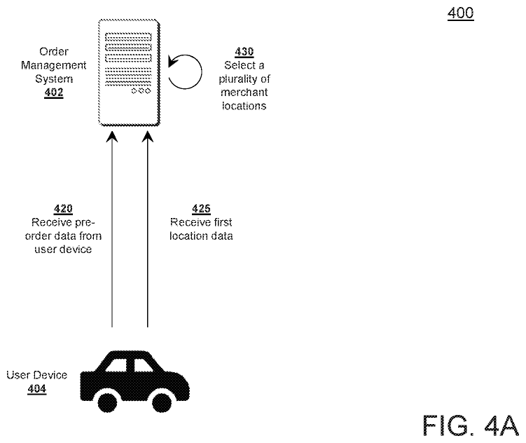

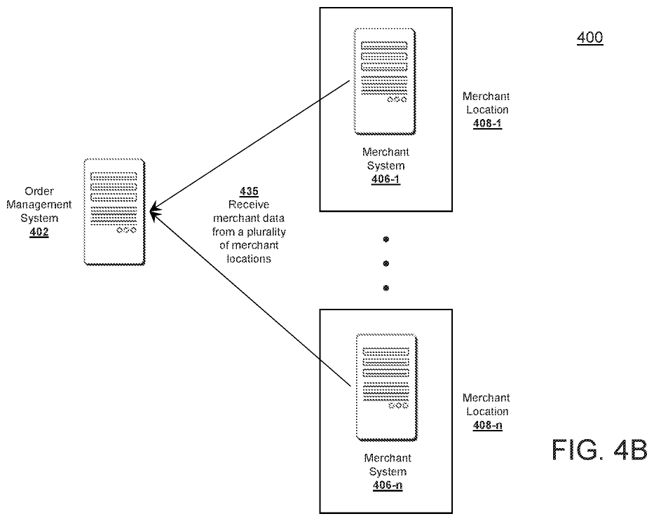

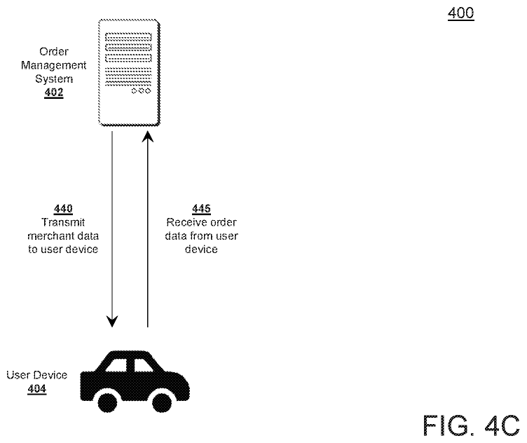

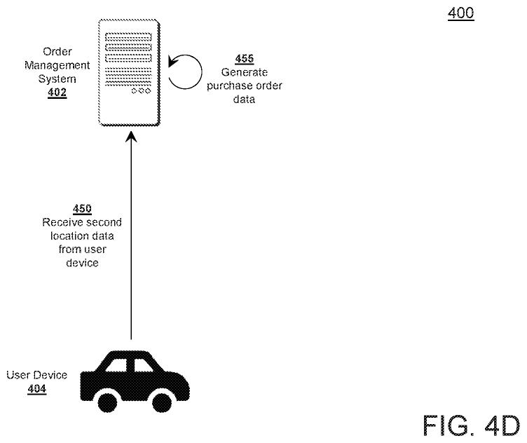

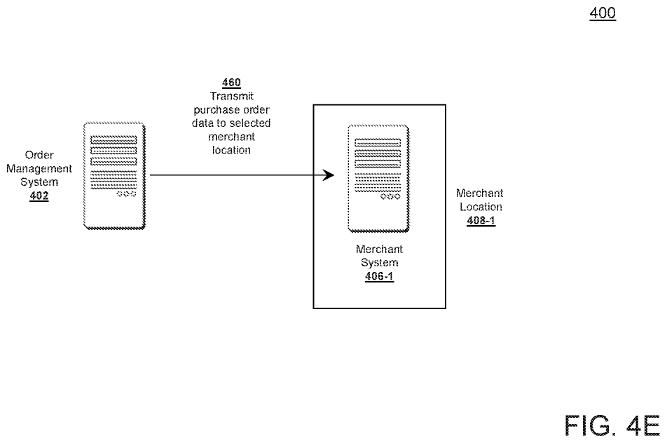

FIGS. 4A-4E are of an overview of a non-limiting embodiment of an implementation 400 for reducing an amount of time between a time at which a purchase order for one or more items is transmitted and a time at which the one or more items is ready to be picked up by a customer. As shown in FIGS. 4A-4E, implementation 400 may include order management system 402, user device 404, merchant systems 406-1 through 406-n, and merchant locations 408-1 through 408-n. In some non-limiting embodiments, order management system 402 may be the same or similar to order management system 102. In some non-limiting embodiments, user device 404 may be the same or similar to user device 104. In some non-limiting embodiments, merchant systems 406-1 through 406-n and merchant locations 408-1 through 408-n may be the same or similar to merchant systems 106-1 through 106-n and merchant locations 108-1 through 108-n.

As shown by reference number 420 in FIG. 4A, order management system 402 may receive pre-order data associated with a pre-order request from user device 404. The pre-order request may include a request for information associated with one or more items available for inclusion in an order to be placed by user device 404. In some non-limiting embodiments, the pre-order data may be generated by user device 404 based on input received at user device 404 (e.g., based on receiving a text query input via an input component of user device 404 and/or a voice query input via an input component of user device 404). Additionally or alternatively, user device 404 may communicate with a machine learning system to generate a pre-order request that is transmitted to order management system 402.

As shown by reference number 425 in FIG. 4A, order management system 402 may receive first location data associated with a first location of user device 404 from user device 404. As shown by reference number 430 in FIG. 4A, order management system 402 may select a first plurality of merchant locations. For example, order management system 402 may select the first plurality of merchant locations based on the pre-order request and/or the first location of user device 404.

As shown by reference number 435 in FIG. 4B, order management system 402 may receive merchant data from a plurality of merchant locations 408-1-408-n. In some non-limiting embodiments, order management system 402 may receive the merchant data from the plurality of merchant locations 408-1-408-n based on transmitting a plurality of merchant data request messages to each of the plurality of merchant locations 408-1-408-n. In such examples, the plurality of merchant data request messages may be configured to cause the plurality of merchant locations 408-1-408-n to generate and transmit merchant data associated with the merchant locations 408-1-408-n to order management system 402. In some non-limiting embodiments, the merchant location data may include item identification data associated with one or more items offered for sale by the merchant location, current wait time data associated with a current wait time of the merchant location 408-1-408-n, and/or order preparation time data associated with an order preparation time of the merchant location 408-1-408-n.

As shown by reference number 440 in FIG. 4C, order management system 402 may transmit merchant data to user device 404. For example, order management system 402 may transmit the merchant data to user device 404 based on receiving merchant data from one or more merchant systems 406-a-406-n associated with merchant locations 408-1-408-n.

As shown by reference number 445 in FIG. 4C, order management system 402 may receive order data associated with an order request from user device 404. For example, order management system 402 may receive order data from user device 404, the order data includes parameters of one or more items to be included in a purchase order. In some non-limiting embodiments, order management system 402 may transmit an order confirmation message to confirm that one or more items should be included in a purchase order. In some non-limiting embodiments, order management system 402 may delay generating and/or transmitting purchase order data associated with the purchase order until an order confirmation response message is received from user device 404, the order confirmation response message including an indication as to whether the order request is confirmed.

As shown by reference number 450 in FIG. 4D, order management system 402 may receive second location data from user device 404. For example, order management system 402 may transmit a location request message to user device 404. The location request message may cause user device 404 to determine second location data associated with a second location of user device 404 and transmit the second location data to order management system 402. In some non-limiting embodiments, order management system 402 may continuously receive second location data associated with the second location of user device 404.

As shown by reference number 455 in FIG. 4D, order management system 402 may generate purchase order data associated with a purchase order. For example, order management system 402 may generate the purchase order data based on the order request.

As shown by reference number 460 in FIG. 4E, order management system 402 may transmit the purchase order data to a selected merchant location. For example, order management system 402 may transmit the purchase order data to merchant system 406 at merchant location 408-1, where merchant location 408-1 is determined to be the selected merchant location. In such examples, merchant system 406-1 may cause the order to be prepared prior to or on arrival of user device 404 at merchant location 408-1. In some non-limiting embodiments, order management system 402 may generate and transmit navigation data associated with a navigable route toward merchant location 408-1 to user device 404 to cause user device 404 to display the navigable route toward merchant location 408-1.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method for reducing an amount of time between a time at which a purchase order for one or more items is transmitted and a time at which the one or more items is ready to be picked up by a customer, the computer-implemented method comprising:
receiving, with at least one processor, a pre-order request message comprising pre-order request data associated with a pre-order request for one or more items from a user device;
receiving, with at least one processor, a first location message comprising first location data associated with a first location of the user device;
selecting, with at least one processor, a first plurality of merchant locations from a second plurality of merchant locations based on the pre-order request data associated with the pre-order request and the first location data associated with the first location of the user device;
receiving, with at least one processor, merchant location messages comprising merchant location data associated with each merchant location of the first plurality of merchant locations, wherein each of the merchant location messages comprise:
item identification data associated with an identification of one or more items offered for sale by the merchant location,
merchant location current wait time data associated with a current wait time of the merchant location, wherein the current wait time comprises an amount of time for a customer to receive one or more items after the customer has placed a purchase order for the one or more items at the merchant location, and
transmitting, with at least one processor, a pre-order response message comprising at least one of the item identification data and the merchant location current wait time data;
receiving, with at least one processor, an order message including data associated with an order for one or more items from the user device;
receiving, with at least one processor, a second location message comprising second location data associated with a second location of the user device;
selecting, with at least one processor, a subset of merchant locations from the first plurality of merchant locations based on:
the merchant location data associated with each merchant location of the first plurality of merchant locations,
the data associated with the order, and
the second location data associated with the second location of the user device; and
transmitting, with at least one processor, a purchase order message comprising purchase order data associated with a purchase order for one or more items to a merchant system of a merchant location of the subset of merchant locations.

2. The computer-implemented method of claim 1, wherein selecting the subset of merchant locations from the first plurality of merchant locations comprises:
calculating weighted scores for each merchant location of the first plurality of merchant locations based on the merchant location data associated with each merchant location of the first plurality of merchant locations; and
selecting the subset of merchant locations from the first plurality of merchant locations based on the weighted scores for each merchant location of the subset of merchant locations.

3. The computer-implemented method of claim 1, wherein selecting the first plurality of merchant locations from the second plurality of merchant locations comprises:
determining a navigable route for a vehicle associated with the user device; and
selecting the first plurality of merchant locations from the second plurality of merchant locations based on the navigable route for the vehicle associated with the user device.

4. The computer-implemented method of claim 1, wherein transmitting the purchase order message to the merchant system of the merchant location of the subset of merchant locations comprises:
transmitting the purchase order message to the merchant system of the merchant location based on determining that the user device is within a predetermined distance of the merchant location.

5. The computer-implemented method of claim 1, wherein receiving the merchant location messages comprises:
receiving a merchant location message from each merchant system of a plurality of merchant systems, wherein each merchant system of the plurality of merchant systems is associated with a merchant location of the first plurality of merchant locations.

6. The computer-implemented method of claim 1, further comprising:
transmitting an authorization request message for a payment transaction based on the purchase order data associated with the purchase order for one or more items;
receiving an authorization response message including an indication of whether the payment transaction is authorized; and
determining that the payment transaction is authorized based on the authorization response message.

7. The computer-implemented method of claim 1, further comprising:
selecting the merchant location of the subset of merchant locations based on determining that the merchant location of the subset of merchant locations is the merchant location that is closest to the second location of the user device.

8. A system for reducing an amount of time between a time at which a purchase order for one or more items is transmitted and a time at which the one or more items is ready to be picked up by a customer, comprising at least one processor programmed or configured to:
receive pre-order request data associated with a pre-order request for one or more items;
select a first plurality of merchant locations from a second plurality of merchant locations based on the pre-order request data associated with the pre-order request;
receive merchant location data associated with each merchant location of the first plurality of merchant locations, wherein the merchant location data comprises:
merchant location current wait time data associated with a current wait time of a merchant location, wherein the current wait time comprises an amount of time for a customer to receive one or more items after the customer has placed a purchase order for the one or more items at the merchant location, and
transmitting, with at least one processor, the merchant location current wait time data;
receive data associated with an order;
select a subset of merchant locations from the first plurality of merchant locations based on the data associated with the order; and
transmit purchase order data associated with a purchase order for one or more items to a merchant system of a merchant location of the subset of merchant locations.

9. The system of claim 8, wherein the at least one processor is further programmed or configured to:
select the merchant location of the subset of merchant locations based on determining that the merchant location of the subset of merchant locations is the merchant location of the subset of merchant locations that is closest to a location of a user device.

10. The system of claim 8, wherein the at least one processor is further programmed or configured to:
select the merchant location from the subset of merchant locations based on determining that the merchant location has the shortest current wait time among the subset of merchant locations.

11. The system of claim 8, wherein when receiving the merchant location data associated with each merchant location of the first plurality of merchant locations, the at least one processor is programmed or configured to:
receive the merchant location data associated with each merchant location of the first plurality of merchant locations from each merchant system of a plurality of merchant systems, wherein each merchant system of the plurality of merchant systems is associated with a merchant location of the first plurality of merchant locations.

12. The system of claim 8, wherein the at least one processor is further programmed or configured to:
receive location data associated with a location of a user device; and
wherein when selecting the first plurality of merchant locations from the second plurality of merchant locations, the at least one processor is programmed or configured to:
select the first plurality of merchant locations from the second plurality of merchant locations based on the location data associated with the location and the pre-order request data associated with the pre-order request.

13. The system of claim 8, wherein when selecting the subset of merchant locations from the first plurality of merchant locations, the at least one processor is programmed or configured to:
calculate weighted scores for each merchant location of the first plurality of merchant locations based on the merchant location data associated with each merchant location of the first plurality of merchant locations; and
select the subset of merchant locations from the first plurality of merchant locations based on the weighted scores for each merchant location of the subset of merchant locations.

14. The system of claim 8, wherein when receiving the pre-order request data associated with the pre-order request for one or more items, the at least one processor is programmed or configured to:
receive the pre-order request data associated with the pre-order request for one or more items from a user device; and
wherein when selecting the first plurality of merchant locations from the second plurality of merchant locations, the at least one processor is programmed or configured to:
determine a navigable route for a vehicle associated with a user device; and
select the first plurality of merchant locations from the second plurality of merchant locations based on the navigable route for the vehicle associated with the user device.

15. A computer program product for reducing an amount of time between a time at which a purchase order for one or more items is transmitted and a time at which the one or more items is ready to be picked up by a customer, the computer program product comprising at least one non-transitory computer-readable medium comprising one or more instructions that, when executed by at least one processor, cause the at least one processor to:
receive pre-order request data associated with a pre-order request for one or more items;
receive first location data associated with a first location of a user device;
select a first plurality of merchant locations from a second plurality of merchant locations based on the pre-order request data associated with the pre-order request and the first location data associated with the first location of the user device;
receive merchant location data associated with each merchant location of the first plurality of merchant locations, wherein the merchant location data comprises:
merchant location current wait time data associated with a current wait time of the merchant location, wherein the current wait time comprises an amount of time for a customer to receive one or more items after the customer has placed a purchase order for the one or more items at the merchant location, and
transmit the merchant location current wait time data;
receive order data associated with an order for one or more items;
receive second location data associated with a second location of the user device;
select a subset of merchant locations from the first plurality of merchant locations based on:
the merchant location data associated with each merchant location of the first plurality of merchant locations,
the order data associated with the order, and
the second location data associated with the second location of the user device; and
transmit purchase order data associated with a purchase order for one or more items to a merchant system of a merchant location of the subset of merchant locations.

16. The computer program product of claim 15, wherein the one or more instructions further cause the at least one processor to:
select the merchant location of the subset of merchant locations based on determining that the merchant location of the subset of merchant locations is the merchant location of the subset of merchant locations that is closest to a location of a user device.

17. The computer program product of claim 15, wherein the one or more instructions further cause the at least one processor to:
select the merchant location from the subset of merchant locations based on determining that the merchant location has the shortest current wait time among the subset of merchant locations.

18. The computer program product of claim 15, wherein the one or more instructions that cause the at least one processor to receive the merchant location data associated with each merchant location of the first plurality of merchant locations, cause the at least one processor to:
receive the merchant location data associated with each merchant location of the first plurality of merchant locations from each merchant system of a plurality of merchant systems, wherein each merchant system of the plurality of merchant systems is associated with a merchant location of the first plurality of merchant locations.

19. The computer program product of claim 15, wherein the one or more instructions that cause the at least one processor to select the subset of merchant locations from the first plurality of merchant locations, cause the at least one processor to:
calculate weighted scores for each merchant location of the first plurality of merchant locations based on the merchant location data associated with each merchant location of the first plurality of merchant locations; and
select the subset of merchant locations from the first plurality of merchant locations based on the weighted scores for each merchant location of the subset of merchant locations.

20. The computer program product of claim 15, wherein the one or more instructions that cause the at least one processor to receive the pre-order request data associated with the pre-order request for one or more items, cause the at least one processor to:
receive the pre-order request data associated with the pre-order request for one or more items from the user device; and
wherein the one or more instructions that cause the at least one processor to select the first plurality of merchant locations from the second plurality of merchant locations, cause the at least one processor to:
determine a navigable route for a vehicle associated with a user device; and
select the first plurality of merchant locations from the second plurality of merchant locations based on the navigable route for the vehicle associated with the user device.
